(19) United States
(12) Patent Application Publication
(10) Pub. No.: US 2004/0191662 A1
(43) Pub. Date: Sep. 30, 2004

(54) Toner for developing electrostatic images containing specified binder resin, process for preparing the same,developer for developing electrostatic images, and image forming method

(75) Inventors: Yasuo Matsumura, Minamiashigara-shi (JP); Kazuhiko Yanagida, Minamiashigara-shi (JP); Manabu Serizawa, Minamiashigara-shi (JP); Hidekazu Yaguchi, Minamiashigara-shi (JP); Tsutomu Kubo, Minamiashigara-shi (JP); Shigeru Seitoku, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/658,811

(22) Filed: Sep. 10, 2003

(30) Foreign Application Priority Data
Mar. 24, 2003 (JP) 2003-79277

(51) Int. Cl. G03G 9/087

(52) U.S. Cl. 430/109.3; 430/137.14; 430/110.3

(57) ABSTRACT

The present invention provides: a toner for developing electrostatic images including as a main component thereof a binder resin having a copolymer comprised of a combination of a high Tg monomer having a structure represented by the following structural formula (1) and a glass transition temperature of 50° C. or higher, a low Tg monomer having a structure represented by the following structural formula (2) and a glass transition temperature of lower than 50° C., and a hydrophilic monomer having a structure represented by the following structural formula (3); a process for preparing the toner for developing electrostatic images; a developer for developing electrostatic images containing the toner; and an image forming method using the toner.

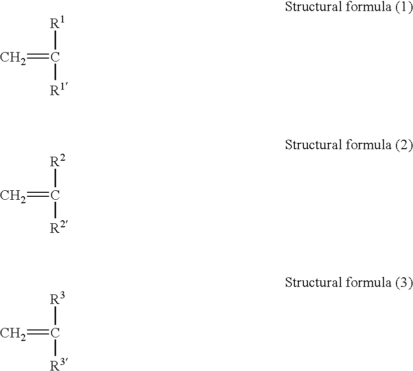

### CROSS-REFERENCE TO RELATED APPLICATION

This application claims priority under 35 USC 119 from Japanese Patent Application NO. 2003-79277, the disclosure of which is incorporated by reference herein.

### BACKGROUND OF THE INVENTION

1. Field of the Invention

The present invention relates to a toner for developing electrostatic images used when an electrostatic latent image formed by an electrophotographic method or an electrostatic recording method is developed with a developer, a process for preparing the same, a developer for developing electrostatic images, and an image forming method.

2. Description of the Related Art

A method of visualizing image information via an electrostatic latent image such as an electrophotographic method is currently utilized in various fields such as copying machines and printers with advances in technology and expanded market demand. In the electrophotographic method, an electrostatic latent image is formed on a photoreceptor by a charging step and an exposing step, and the electrostatic latent image is developed with a developer containing a toner, and the resultant toner image is fixed on a recording medium via a transferring step and a fixing step. Developer types that are used include a two-component developer comprising a toner and a carrier, and a one-component developer using a magnetic toner or a non-magnetic toner alone.

As a process for preparing the toners, usually, a kneading and grinding process is used in which a thermoplastic resin is melted and kneaded with a pigment, a charge control agent, a releasing agent and the like, and is cooled, finely pulverized, and classified. To the surface of the resultant particles, inorganic or organic fine particles may be added to improve flowing property or cleaning property of the toner, if necessary.

In a usual kneading and grinding process, the shapes and surface structures of toner particles are undefined, and subtly change depending on the grinding property of materials used and the conditions of a grinding step and, therefore, it is difficult to intentionally control the shapes and surface structures of toner particles. In particular, when the material has high grinding property, a mechanical force in a developing machine frequently leads to production of a fine powder, and change in toner shape. In a two-component developer, such effects accelerate deterioration in chargeability of a developer due to adhesion of the fine powder to the carrier surface. In a one-component developer, the above effects cause scattering of a toner due to expansion of a particle size distribution, and deterioration in image quality due to reduced developing property of the toner arising from change in toner shape.

In addition, when a releasing agent such as wax is internally added to prepare a toner, exposure of the releasing agent on the surface of the toner is often influenced by a combination with a thermoplastic resin. In particular, in a combination of a resin which is given elasticity by a high-molecular component and is relatively hard to grind and a brittle wax-type releasing agent such as polyethylene, exposure of polyethylene on the toner surface is observed in many cases. Although this is advantageous from the viewpoint of releasability of the toner at the time of fixation and cleaning of an untransferred toner from a photoreceptor, polyethylene on the superficial layer of the toner easily migrates due to a mechanical force, which easily contaminates a developing roll, a photoreceptor and a carrier, leading to reduced reliability of a developer. Since the toner shape is undefined, addition of a flowing aid to the toner cannot sufficiently improve the flowing property of the toner, and fine particles on the toner surface move to recess portions due to action of a mechanical force during use. Therefore, the flowing property of the toner diminishes over time, and the flowing aid is embedded in the toner, resulting in deterioration in developing, transferring, and cleaning properties of the toner. When a toner retrieved by cleaning returns to a developing machine and is used again, image quality easily deteriorates. When the amount of the flowing aid is increased in order to prevent this, black points generate on a photoreceptor and the aid particles scatter.

In recent years, as a method of intentionally controlling the shapes and surface structures of toner particles, a process for a preparing a toner by an emulsification polymerization aggregating method has been proposed. By this emulsification polymerization aggregating method, a toner having a small diameter can be prepared effectively, in theory, since starting materials are usually used in the form of fine particles having a size of 1 micron or smaller. More particularly, this process is generally a process for preparing a toner by preparing a resin dispersion liquid by emulsification polymerization and, separately, preparing a colorant dispersion liquid in which a colorant is dispersed in a solvent, mixing these resin dispersion liquid and colorant dispersion liquid to form aggregated particles having a diameter corresponding to a toner particle diameter and, thereafter, heating the aggregated particles to fuse and coalesce the particles. However, since in this process, the surface and the interior of the toner usually have the same composition, it is difficult to intentionally control the surface composition (refer to, for example, Japanese Patent Application Laid-Open (JP-A) Nos. 63-282752 and 6-250439).

To solve this problem, a method has been proposed for realizing more precise control of a particle structure by freely controlling compositions or formulation from an interior layer to a surface layer also in a toner obtained by the emulsification polymerization aggregating method. Since miniaturization of the diameter of these toners is easy and more precise control of a particle structure has been realized, the image quality of the conventional electrophotographic image has dramatically improved, and it has become possible to realize high reliability at the same time (refer to, for example, Japanese Patent No. 3141783).

Meanwhile, in recent years, an image forming method by electrophotography using the aforementioned toner/developer technology has begun to be applied to a part of the printing region with advancements in digitalization and colorization, and has been put into practice noticeably in the graphic arts market including on-demand printing. The graphic arts market refers to the overall print preparing-related business market such as copying and duplication of originals such as creative prints which are copied in small quantities such as woodblock prints, handwriting and pictures, and mass production printing called reproduction, and is defined as the market targeting industries and divisions associated with preparation of prints. For example, in the short run printing market, technologies have been developed which target not only monochrome printing utilizing the characteristics of plateless printing in electrophotography, but also the short run color market, a representative being a machine Color DocuTech 60 manufactured by Fuji Xerox Co., Ltd. These technologies have greatly progressed in terms of image quality, paper adaptability, product price and printing price per sheet (refer to, for example, Bulletin of Japan Image Society, Vol. 40 No. 2 2001).

However, when compared with original genuine conventional printing, although the on-demand characteristics as plateless printing are present, problems arise such as: image defects and deteriorated writing properties resulting from image quality such as color reproduction region, resolution, glossiness, and texture, image uniformity within the same image, preservability of image quality when printing continuously for a long period, high cost per print due to the amount of toner consumed in high density image, adaptability to thinner paper and thicker paper, oil at the time of image fixing, high consumption of electric power at high speed and high temperature fixing, and elongation, curling, and waving of a paper sheet due to image fixation at high temperature and high pressure, and a shear in a register at the time of printing on both surfaces. Since in theory a toner image comprising a low-molecular resin having a relatively low softening point is thermally fixed, there is a case where the thermal or mechanical durability of the image is weaker than that of a printed image. When a paper sheet is folded several times, or paper sheets are subjected to bookbinding, piled multiply and exposed to high temperature under a high load state, in some cases, problems in durability arise under various kinds of stress such as light resistance and weather resistance accompanied with image fracture, blocking, offsetting and outdoor exposure.

It has become apparent that many issues remain to be solved in order to have images formed by electrophotography considerably replace conventional printed material and enhance market value, particularly as a production means in the area of graphic arts.

Regarding color reproduction region, the types of pigments which have been put into practice in an electrophotographic region are fewer than those used in conventional printing ink, and technologies are needed for further high performance colorants. Since usage conditions in the graphic arts area are diverse as compared with the office market, not only high color reproductivity, but also various durability properties are required of an image such as heat resistance, light resistance, water resistance, oil resistance, solvent resistance, scratch resistance and bending strength. Although resolution is easily restricted by diameters of toner particles, and a distribution thereof in an image processing system, a photoreceptor and an exposure system, major technical issues remain to be solved in order to effectively use a small diameter toner with high reliability in respective processes such as charging, development, transfer, fixing and cleaning. Examples of such technical issues include: a carrier for uniformly charging a small diameter toner, design of a charging blade and a charging roll, a developing system for obtaining high image density without causing stain of a background portion, a transfer system for realizing transfer at a precision and high transfer efficiency, a fixing system for handling a combination of the small diameter toner and various types of paper, and a cleaning system for completely removing the small diameter toner on a photoreceptor or an intermediate transferring member to realize stable image quality.

In order to improve in-plane uniformity and defects of an image, controlling uniformity of the developing ability of a developer in an image forming system becomes important. Satisfying demands of the printing market regarding sustainability of image quality requires retaining stable charging property and stable and uniform development even when continuously printing an image or images of several thousand sheets, and using a highly durable developer that has minimal environmental dependency on temperature and humidity. Furthermore, a developing system must be optimized so as to avoid influences of paper powder and foreign matter, be highly durable, able to suppress occurrence of defects and noise, and be able to maintain uniform in-plane density.

In a system for performing transfer from a photoreceptor or an intermediate transferring member, an electrostatic transfer system is common in current electrophotographic technology. However, when a color image in which a thickness of a toner image becomes thick by color overlapping, in order to suppress deterioration of an image due to toner scattering during transfer, optimization of toner materials and a transfer system are necessary to precisely control the behavior of a toner in an electric field. In some cases, a transfer system which can radically suppress toner scattering and which is not based on an electrostatic force such as adhering transfer becomes necessary.

As a cleaning system, it is important to optimize a system so that a toner of controlled shape such as a small diameter and a spherical shape can be cleaned continuously with high reliability without being affected by the environment. This is achieved by a method using a blade, an electrostatic brush, a magnetic brush, or web, or cleaning simultaneously with development, by selecting a highly durable photoreceptor, toner materials and a structure, and a hard system.

Regarding cost per sheet, it is necessary to reduce the amount of consumed toner by preparing a toner having a small diameter, and optimizing the amount of a colorant. However, this easily affects uniformity of image quality. By realizing an image forming system having high reliability by the above-mentioned means, decreasing “waste sheet” (waste output for obtaining stable image quality) which greatly affects printing prices, or decreasing the maintenance load, also become important factors in actually reducing cost per sheet.

Regarding use of thin paper and thick paper, when using thin paper which is inelastic, or plastic film, it is necessary that the paper or film can be easily peeled from fixing members such as a fixing roll after fixation. Moreover, in order to suppress the amount of electric power consumption, toner materials with low temperature fixation property are required when fixing toner on coated paper or thick paper. Fixation at low temperature and low pressure can reduce stress applied to paper, suppress elongation, curling and waving of paper, and can also overcome problems such as register printing shear. To prevent image defects and deteriorated writing properties such as blurs and streaks caused by oil stains, an oil-less fixing apparatus and oil-less toner containing a releasing agent in the interior thereof become necessary.

Additionally, in order to realize image durability which is comparable to an ordinary printed image and which does not cause problems under various usage conditions, the properties of resin used in a conventional toner must be improved considerably.

In order to make glossiness of an image have a higher degree of flexibility and uniformity, control of viscoelasticity of a toner and optimization of a fixing apparatus are important. To obtain an image of high quality based on offset printing, it is important to realize glossiness that is optimum for paper to be used so that market value can be enhanced. Thus, optimization in all three areas of toner, paper, and fixing system are necessary.

A characteristic sought in recent years in fields such as on-demand printing and the like include environmental load performance. Making printing business on-demand by a network allows inventory to be kept at a minimum level or no need to carry inventory, which can reduce environmental load caused by inventory, movement, and disposal of printed material easily generated in ordinary printing. Since a dry toner used in ordinary electrophotography does not contain an organic solvent in ink used with ordinary printing machines, environmental load involved with VOC can be radically reduced. However, for further improvement, important issues include not only reduction in electric energy used during fixation of an image and during maintenance of hardware conditions, but also reduction or nonuse of odor or volatile substances that are generated from heated and melted resin during fixation, and suppression of discharge of a small diameter toner component from a machine. It is also necessary to consider the recycling properties of wasted toner and printed paper.

Thus, in order to respond to demand in the graphic arts market and short run market (which may also be referred to as the light printing market), technology which has developed further as a system from conventional electrophotographic technology, has become necessary.

Under such circumstances, in order to enable application to not only an image on paper but also various utilities such as advertisements, signboards and posters, it is important to realize an image having high durability and weather resistance. For such a realization, not only selection of a colorant, and the chemical structure and dispersing structure of the colorant, but also the chemical structure and physical properties of a binder resin which serves as a matrix for the colorant, and selection of additives are important.

A toner including a resin made of a vinyl monomer has been commonly used, and most of the vinyl monomers used for such resins are a styrene monomer. This is because the styrene monomer is extremely inexpensive as a vinyl monomer and use of styrene as a monomer component of such a resin increases brittleness of the resin, whereby grinding efficiency at the time of preparation of a toner by a kneading and grinding process is enhanced and an inexpensive toner is obtained.

However, styrene often causes problems under various usage conditions of an exposing environment, such as weather resistance such as yellowing caused by sunlight, or image strength due to brittleness originally possessed by styrene.

As a binder resin for a vinyl type toner not containing a styrene monomer, a crystalline polyolefin copolymer has been proposed. However, although crystalline polyolefin is advantageous for obtaining low temperature fixing properties, it tends to be slightly weak in transparency and image durability of a fixed image, and there is a limitation when the high image quality color copying market and the graphic arts market are taken into consideration (refer to, for example, Japanese patent Application Laid-Open (JP-A) Nos. 9-218853, 9-329917, 10-186724 and 10-186716).

Under such circumstances, in a toner manufactured by the aforementioned emulsification polymerization aggregating method, since brittleness of the resin does not necessarily restrict a process for preparing a toner, it has been found that resins composed of various monomers can be used.

In the conventional process for preparing a toner, a resin, a pigment and other additives are mixed, heated and kneaded, ground and classified to obtain a toner having a desired particle diameter. However, since a process temperature at the time of kneading is 100° C. to 250° C., being approximately equal to a temperature at which a toner is fixed on a transfer medium such as paper with a heating roll, it is difficult to incorporate a reaction system having temperature selectivity into a toner.

Accordingly, there has been a need for a toner for developing electrostatic images which can form a color image of high quality and durability having a wide color reproducing range, can reduce occurrence of odor and volatile matters at the time of thermal fixation, exhibits excellent light resistance, developing property and transferring property, and can provide a clear image of the high quality; a process for preparing the toner for developing electrostatic images; a developer for developing electrostatic images; and an image forming method.

### SUMMARY OF THE INVENTION

The inventors of the invention have studied a binder resin whose monomer(s) does not include a styrene monomer and, as a result, have found that a toner containing as a main component thereof a binder resin having a copolymer comprising a highly hydrophilic monomer, a monomer having a high glass transition temperature, and a monomer having a low glass transition temperature solves the aforementioned problems and have completed the invention.

A first aspect of the invention provides a toner for developing electrostatic images, comprising as a main component thereof a binder resin having a copolymer comprising a combination of a high Tg monomer having a structure represented by the following structural formula (1) and a glass transition temperature of 50° C. or higher, a low Tg monomer having a structure represented by the following structural formula (2) and a glass transition temperature of lower than 50° C., and a hydrophilic monomer having a structure represented by the following structural formula (3):

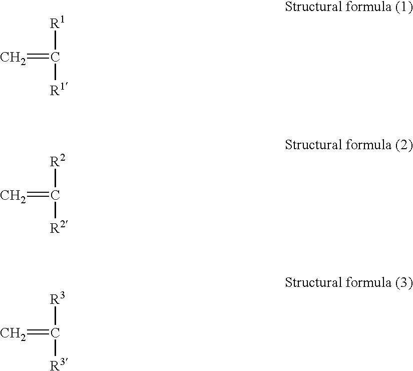

wherein R¹, R² and R³ independently represent a hydrogen atom, an alkyl group, an alkylester group, an alkylether group, a perfluoroalkyl group, a methoxy group, an ethoxy group, a halogen atom, a carbazole group, a pyrrolidone group, a formal group, a cyclohexyl group, an alkyl group having a functional group, or an alkylester group having a functional group, R^{1′} and R^{2′} independently represent an alkyl group, an alkylester group, an alkylether group, a perfluoroalkyl group, a methoxy group, an ethoxy group, a halogen atom, a carbazole group, a pyrrolidone group, a formal group, a cyclohexyl group, an alkyl group having a functional group, or an alkylester group having a functional group, and R^{3′} represents a hydrophilic group.

Moreover, a second aspect of the invention provides a developer for developing electrostatic images, which comprises the aforementioned toner for developing electrostatic images.

Further, a third aspect of the invention provides a process for preparing the aforementioned toner, comprising an aggregating step of obtaining aggregated particles by aggregating particles containing a binder resin in a dispersion in which the particles are dispersed, and a fusing step of fusing the aggregated particles by heating.

A fourth aspect of the invention provides an image forming method, comprising the steps of: forming an electrostatic latent image on an electrostatic image holding member, developing the electrostatic latent image with a developer to form a toner image, transferring the toner image onto a transfer receiving material, and thermally fixing the toner image, wherein the developer contains the aforementioned toner.

### DETAILED DESCRIPTION OF THE INVENTION

<Toner for Developing Electrostatic Images>

A toner for developing electrostatic images of the present invention comprises as a main component thereof a binder resin having a copolymer comprised of a combination of a high Tg monomer having a structure represented by the following structural formula (1) and a glass transition temperature of 50° C. or higher, a low Tg monomer having a structure represented by the following structural formula (2) and a glass transition temperature of lower than 50° C., and a hydrophilic monomer having a structure represented by the following structural formula (3).

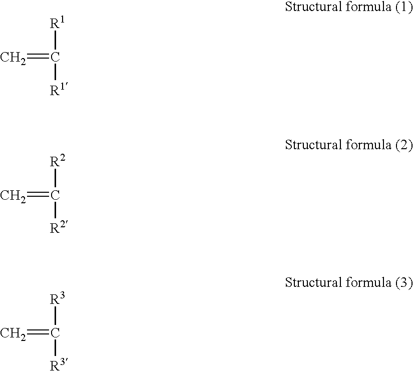

wherein R¹, R² and R³ independently represent a hydrogen atom, an alkyl group, an alkylester group, an alkylether group, a perfluoroalkyl group, a methoxy group, an ethoxy group, a halogen atom, a carbazole group, a pyrrolidone group, a formal group, a cyclohexyl group, an alkyl group having a functional group, or an alkylester group having a functional group, R^{1′} and R^{2′} independently represent an alkyl group, an alkylester group, an alkylether group, a perfluoroalkyl group, a methoxy group, an ethoxy group, a halogen atom, a carbazole group, a pyrrolidone group, a formal group, a cyclohexyl group, an alkyl group having a functional group, or an alkylester group having a functional group, and R^{3′} represents a hydrophilic group.

In the invention, a hydrophilic group refers to a group which makes a homopolymer made of a monomer having a structure represented by the aforementioned formula (3) when R³ is a hydrogen atom water-soluble.

It is preferable that the hydrophilic group represented by R^{3′} contains any of a carboxyl group, a hydroxyl group, an amino group, a sulfonyl group, and an amido group.

The toner for developing electrostatic images of the invention (hereinafter, simply referred to as “toner” in some cases) including as a main component thereof a binder resin having a copolymer (hereinafter, simply referred to as “copolymer of the invention”) comprised of a combination of a high Tg monomer having a structure represented by the aforementioned structural formula (1) and a glass transition temperature of 50° C. or higher (hereinafter, simply referred to as “high Tg monomer”), a low Tg monomer having a structure represented by the aforementioned structural formula (2) and a glass transition temperature of lower than 50° C. (hereinafter, simply referred to as “low Tg monomer”), and a hydrophilic monomer having a structure represented by the aforementioned structural formula (3) (hereinafter, simply referred to as “hydrophilic monomer”) does not emit odor or volatile components unlike a conventional electrostatic image development toner containing a styrene type compound, is excellent in low temperature fixing property, the fixed image durability, toner preservability, fixing properties such as resistance to hot offsetting, and surface glossiness of a fixed image, developing property and transferring property and enables formation of an image having excellent image quality.

The copolymer in the invention will be explained below.

The copolymer in the invention is comprised of a combination of a high Tg monomer, a low Tg monomer and a hydrophilic monomer. Regarding a typical composition ratio of each monomer in the copolymer in the invention, it is preferable that a ratio of the high Tg monomer and the low Tg monomer (high Tg monomer:low Tg monomer) is in the range of 50:50 to 95:5. In addition, a ratio of the hydrophilic monomer relative to each monomer is preferably 0.5 to 10% by mass, and more preferably 1 to 5% by mass. When the composition ratio of each monomer in the copolymer in the invention is in the aforementioned preferable range, the effect of the invention becomes more remarkable.

Specific examples of the high Tg monomer include methyl methacrylate, ethyl methacrylate, isopropyl methacrylate, vinylpyrrolidone, vinylformal, vinylcarbozole, cyclohexylethylene, vinyl chloride, acrylonitrile, vinylacetal, hexafluoropropylene, methylchloroacrylic acid, ethylchloroacrylic acid and vinylisobutyral.

Examples of the low Tg monomer include butyl acrylate, butyl methacrylate, dodecyl methacrylate, glycidyl methacrylate, octadecyl methacrylate, octyl methacrylate, pentyl methacryalte, propyl methacrylate, tetradecyl methacrylate, vinyl methyl ether, vinyl ethyl ether, vinyl butyl ether, vinyl isobutyl ether, vinylbutyral, vinyl acetate, and butylchloroacrylic acid.

Examples of the hydrophilic monomer include monomers having a nitrogen-containing polar group such as an amido group, an amino group and the like, and vinylcarboxylic acids such as methacrylic acid, acrylic acid, cinnamic acid and carboxyethyl acrylate.

Examples of a typical combination of each monomer in the copolymer in the invention include a combination of methyl methacrylate as the high Tg monomer, butyl acrylate as the low Tg monomer and acrylic acid as the hydrophilic monomer, a combination of ethyl methacrylate as the high Tg monomer, butyl methacrylate as the low Tg monomer and carboxyethyl acrylate as the hydrophilic monomer, a combination of vinylisobutyral as the high Tg monomer, octyl methacrylate as the low Tg monomer and methacrylic acid as the hydrophilic monomer, and the like.

In the copolymer in the invention, it is preferable that at least one of the high Tg monomer and the low Tg monomer is a methacrylic ester or an acrylic ester.

The aforementioned toner of the invention may be prepared by any process, and is preferably prepared via at least an aggregating step of aggregating particles comprising fine particles of a binder resin (hereinafter, referred to as “binder resin fine particles” in some cases) having a copolymer comprised of a combination of the high Tg monomer, a low Tg monomer and the hydrophilic monomer in a dispersion of the particles to obtain aggregated particles, and a step of heating the aggregates particles to fuse them.

It is preferable that the binder resin in the invention contains at least one type of reactive group, and that the reactive group is cross-linked at a temperature higher than the highest temperature at the time of preparation of a toner.

It is preferable that the reactive group is an organic compound group having a cyclic structure (hereinafter, referred to as “cyclic reactive group”). When the cyclic reactive group is incorporated into the binder resin and the toner of the invention is prepared by a process in which a temperature at the time of toner preparation is 100° C. or lower as in an emulsification polymerization aggregating method, fixation at a temperature of 100° C. or higher or heating by post-treatment causes a cross-linking reaction of the toner, and it becomes possible to form a fast toner image.

By incorporating the aforementioned cyclic reactive group into the binder resin in the invention, three properties of low temperature fixing property, preservability of a toner inside or outside a machine, and preservability of an image after fixation which are difficult to realize at the same time, can be realized at the same time and, thus, the effect of the invention becomes more remarkable. In particular, when the cores of toner particles are made of a resin having a relatively low glass transition temperature and a resin having a high glass transition temperature is used in an outer shell of the toner particles, the aforementioned effect becomes even more remarkable.

By enhancing thermal durability of toner surfaces by capsulation, a toner is stably stored outside a machine until use of the toner, caking does not occur even when the temperature rises (approaching around 50° C. in some cases) in the machine at the time of continuous printing, and it becomes possible to design an image forming system having high reliability.

Examples of the cyclic reactive group include polymerizable monomers having an epoxy group, an aziridinyl group or an oxazoline group. Further, when a low-molecular compound or a high-molecular compound which easily causes a cross-linking reaction with the aforementioned reactive group, such as a compound containing a polyvalent carboxyl group is contained in a toner, formation of cross-linking is relatively easily observed after fixation at 100° C. or higher.

Examples of a reaction derived from various combinations will be shown below, and an epoxy group can be easily replaced by another group such as an aziridinyl group and an oxazoline group. In addition, the aforementioned examples are not limited to this example as long as an image forming method having a clearly distinct difference between a highest temperature at the time of processing and preparation and a temperature at the time of fixation is used. A low-molecular compound having a plurality of carboxylic acids can exert the releasing agent effect as in wax by appropriately selecting a melting point of the compound and, at the same time, can effectively realize a cross-linking reaction by diffusion in a binder resin due to sharp melting behavior of the compound, and elution onto the surface of a fixed image.

It is also effective to use a carboxylic acid-containing latex in a resin for forming a shell in capsules. By structurally isolating reactive groups, for example isolating reactive groups in a core from reactive groups in a shell, a polymer reaction is suppressed during preparation of a toner.

Alternatively, it is also effective to have these reactive groups mixed as separate components in a toner, or added into an outer portion of toner particles in the form of an external additive, and melted and mixed by heating, in order to allow reaction.

Examples of such a polymerizable monomer containing a group having reactivity with a polar group, a representative of which is a carboxyl group, include epoxy group-containing monomers such as glycidyl methacrylate, glycidyl acrylate, 2-methylglycidyl methacrylate, 2-methylglycidyl acrylate, allyl glycidyl ether, glycidyl p-vinylbenzoate, methylglycidyl itaconate, glycidylethyl maleate, glycidylvinyl sulfonate, glycidyl-β-styrene sulfonate, glycidylallyl sulfonate, and glycidylmethallyl sulfonate, aziridinyl group-containing polymerizable monomers such as methacryloylaziridine, acryloylaziridine, 2-aziridinylethyl methacrylate, and 2-aziridinylethylacrylate, and oxazoline group-containing polymerizable monomers such as 2-isopropenyl-2-oxazoline, and 2-vinyl-2-oxazoline. One of these types, or a mixture of two or more of these types may be used.

Examples of the polymerizable monomer containing a polar group, a representative of which is a carboxyl group, include acrylic acid, methacrylic acid, crotonic acid, maleic acid, fumaric acid, itaconic acid, and carboxyethylacrylic acid, and monoesters thereof, and salts thereof, and one of these types, or a mixture of two or more of these types may be used.

Examples of a low-molecular compound having a plurality of carboxylic acids include sebacic acid, dodecanediacid, malonic acid, octenylsuccinic acid, oxalic acid, fumaric acid, succinic acid, glutaric acid, dodecylsuccinic acid, adipic acid, pimelic acid, suberic acid, azelaic acid, maleic acid, citraconic acid, itaconic acid, glutaconic acid, isododecenylsuccinic acid, octylsuccinic acid, malic acid, terephthalic acid, isophthalic acid, and dodecenylsuccinic acid. When combined with the aforementioned wet process, a compound which is almost insoluble in water or insoluble in water and has a melting point in a fixing temperature area of 80° C. to 150° C., such as sebacic acid (melting point: 135° C.) and dodecanediacid (melting point: 127° C.) is particularly preferable.

The shape factor SF1 of the toner of the invention is preferably 100 to 140, and more preferably 110 to 135 from the viewpoint of image forming properties. The shape factor SF1 in the invention is obtained as follows. First, a light microscopic image of a toner scattered on a glass slide is taken into a Ruzex image analyzing apparatus through a video camera, maximum lengths (ML) (μm) and projected areas (A) (μm²) of 50 or more toner particles are measured, and the shape factor SF1 is obtained by the following equation (A).

SF1=ML²/(4A/π)×100 Equation (A)

The toner of the invention can have more excellent chargeability, cleaning property and transferring property by adjusting the shape factor SF1 thereof at 100 to 140. When the shape factor SF1 exceeds 140, efficiency of transferring from an electrostatic image holding member carrying a toner image onto a transferring member is reduced, and reliability of the image quality is lost in some cases. In this case, cleaning property refers to blade cleaning which is most commonly used.

By adjusting a surface property index defined by the following equation (B) at 2.0 or smaller, the toner of the invention exhibits good transferring property and adheres uniformly on paper and a transferring medium having large surface roughness, and high image quality can be realized by high transferring efficiency. It is preferable that the surface property index is 1.8 or smaller.

(surface property index value)=(specific surface area measured value)/(specific surface area calculated value) Equation (B)

In the equation (B), the specific surface area calculated value is represented by 6 Σ (n×R²)/{ρ×Σ(n×R³)} and, in the equation representing the specific surface area calculated value, n represents the number of particles in a channel in a coulter counter (number/channel), R represents a channel particle diameter in the coulter counter (μm), and ρ represents a toner density (g/μm³). The division number of the channel is 16, and the intervals of division are 0.1 at a log scale.

In the equation (B), the specific surface area measured value is measured based on a gas adsorbing and desorbing method, and is obtained by obtaining a Langmuir specific surface area. As a measuring apparatus, Coulter SA3100 type (manufactured by Beckman Coulter Inc.) and Gemini 2360/2375 (manufactured by Shimadzu Corporation) can be used.

An apparent weight average molecular weight of the toner of the invention is preferably 15,000 to 55,000, and more preferably 20,000 to 48,000. When the weight average molecular weight is smaller than 15,000, an aggregating force of a binder resin is easily reduced, and the oil-less peeling property is reduced in some cases. When the molecular weight exceeds 55,000, the oil-less peeling property is better, but smoothening at the time of fixation becomes insufficient, and glossiness is reduced in some cases.

A glass transition temperature Tg of a binder resin in the invention is in the range of 45 to 70° C., and preferably 50 to 65° C. When Tg is lower than 45° C., an aggregating force of the binder resin itself is reduced at a high temperature area, and therefore hot offset is caused at the time of fixation in some cases. When Tg exceeds 70° C., sufficient melting cannot be obtained and glossiness of a fixed sheet is reduced in some cases.

An accumulated volume average particle diameter D₅₀ of the toner of the invention is preferably in the range of 3.0 to 9.0 μm, and more preferably 3.0 to 8.0 μm. When D₅₀ is smaller than 3.0 μm, chargeability of the toner becomes insufficient, and developing property of the toner is reduced in some cases. On the other hand, when D₅₀ exceeds 9.0 μm, the resolution of an image is reduced in some cases.

It is preferable that a volume average particle size distribution index GSDv of the toner particles of the invention is 1.30 or smaller. When GSDv exceeds 1.30, resolution is reduced, causing image defects such as toner scattering and fogging in some cases.

Regarding the aforementioned accumulated volume average particle diameter D₅₀ and average particle size distribution index, based on a particle size distribution measured with a measuring apparatus such as Coulter Counter TAII (manufactured by Nikkaki) and Multisizer II (manufactured by Nikkaki), accumulated distributions of a volume and a number are drawn from a small diameter side to a divided particle size range (channel), and a particle diameter at accumulation of 16% is defined as volume D₁₆ᵥ and number D_{16P}, a particle diameter at accumulation of 50% is defined volume D₅₀ᵥ and number D_{50P}, and a particle diameter at accumulation of 84% is defined as volume D₈₄ᵥ and number D_{84P}. By using them, a volume average particle size distribution index GSDv is calculated as (D₈₄ᵥ/D₁₆ᵥ)^{1/2}, and a number average particle size distribution index GSDp is calculated as (D_{84P}/D_{16P})^{1/2}.

A colorant used in the toner of the invention is not particularly limited as long as it is a publicly known colorant. For example, the colorants exemplified below can be used.

Examples of a black pigment include carbon black, copper oxide, manganese dioxide, aniline black, active carbon, non-magnetic ferrite, and magnetite.

Examples of a yellow pigment include chrome yellow, zinc yellow, yellow iron oxide, cadmium yellow, chromium yellow, hanza yellow, hanza yellow 10G, benzidine yellow G, benzidine yellow GR, threne yellow, quinoline yellow, and permanent yellow NCG.

Examples of an orange pigment include red chrome yellow, molybdenum orange, permanent orange GTR, pyrazolone orange, Vulcan orange, benzidine orange G, indantherene brilliant orange RK, and indantherene brilliant orange GK.

Examples of a red pigment include red oxide, cadmium red, red lead, mercury sulfide, watchang red, permanent red 4R, risol red, brilliant carmine 3B, brilliant carmine 6B, duPont oil red, pyrazolone red, rhodamine B rake, lake red C, rose Bengal, eosin red, alizarin lake, and naphthol red such as Pigment Red 146, 147, 184, 185, 155, 238, and 269.

Examples of a blue pigment include Prussian blue, cobalt blue, alkali blue lake, Victoria blue lake, fast sky blue, indanthrene blue BC, aniline blue, ultramarine blue, chalcoil blue, methylene blue chloride, phthalocyanine blue, phthalocyanine green, and malachite green oxalate.

Examples of a purple pigment include manganese purple, fast violet B, and methyl violet lake.

Examples of a green pigment include chromium oxide, chromium green, Pigment Green, malachite green lake, and final yellow green G.

Examples of a white pigment include Chinese white, titanium oxide, antimony white, and zinc sulfide.

Examples of an extender include barites powder, barium carbonate, clay, silica, white carbon, talc, and alumina white.

In addition, examples of a dye include various dyes such as basic, acidic, dispersion and substantive dyes, for example, Nigrocin, methylene blue, rose Bengal, quinoline yellow, and ultra marine blue.

These colorants are used alone or by mixing them. These colorants can be prepared into a dispersion of colorant particles using a media type dispersing machine such as a rotation shearing-type homogenizer, a ball mill, a sand mill, and an attritor, a high pressure opposite collision type dispersing machine, and the like. These colorants may also be dispersed into an aqueous system including a surfactant having polarity with a homogenizer.

The colorant is selected from the viewpoints of hue angle, chroma, brightness, weather resistance, OHP permeability, and dispersibility in a toner.

It is preferable that the content of the colorant is 4 to 15% by mass relative to a total weight of solid matter of the toner.

When a magnetic material is used as a black colorant, it is preferable to add the material in an amount of 12 to 240% by mass unlike other colorants.

By rendering the amount of the colorant to be incorporated in the aforementioned range, better color developing property at the time of fixation can be attained.

In addition, it is preferable that the median diameter of colorant particles in the toner of the invention is 100 to 330 nm. By adjusting the median diameter of the colorant to be 100 to 330 nm, better OHP transparency and color developing property can be attained.

The median diameter of colorant particles is measured, for example, with a laser diffraction particle size distribution measuring apparatus (LA-700: manufactured by Horiba, Ltd.).

When the toner of the invention is used as a magnetic toner, the toner may contain a magnetic powder. Specifically, a material which is magnetized in the magnetic field is used, and a ferromagnetic powder such as iron, cobalt or nickel, or a compound such as ferrite, or magnetite is used. In order to obtain the toner of the invention used as a magnetic toner in an aqueous phase, it is preferable to pay attention to migration of a magnetic material to an aqueous phase, and it is more preferable to modify the surface of the magnetic material in advance, for example, to make the surface hydrophobic.

In addition, for the purpose of further modifying a binder resin in the invention, conventional type resin can be used at the same time. Specific examples of such a binder resin include vinylnaphthalene, vinyl chloride, vinyl bromide, vinyl fluoride, vinyl esters such as vinyl acetate, vinyl propionate, vinyl benzoate and vinyl butyrate, methylene aliphatic carboxylic acid esters such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate, acrylonitrile, methacrylonitrile, acrylamide, vinyl ethers such as vinyl methyl ether, vinyl ethyl ether and vinyl isobutyl ether, monomers having a N-containing polar group such as N-vinyl compounds including N-vinylpyrrole, N-vinylcarbazole, N-vinylindole and N-vinylpyrrolidone, and homopolymers and copolymers of vinyl monomers such as vinyl carboxylic acids including methacrylic acid, acrylic acid, cinnamic acid and carboxyethyl acrylate, various polyesters and various waxes. They can be used in combination.

In the case of a vinyl monomer, a resin fine particle dispersion liquid can be prepared by performing emulsification polymerization using an ionic surfactant. In the case of other resin, when the resin is oily and dissolves in a solvent having relatively low solubility in water, the resin is dissolved in the solvent, and the resultant solution, an ionic surfactant and/or a polymer electrolyte are dispersed into water in the form of fine particles with a dispersing machine such as a homogenizer. Thereafter, the solvent is volatilized by heating the resultant dispersion or reducing the internal pressure of a container containing the dispersion, whereby a resin fine particle dispersion can be obtained.

The median diameter of fine particles in the thus obtained resin fine particle dispersion is 1 μm or smaller, preferably in the range of 50 to 400 nm, and more preferably 70 to 350 nm.

The median diameter of resin fine particles is measured, for example, with a laser diffraction particle size distribution measuring apparatus (LA-700: manufactured by Horiba, Ltd.).

In addition, as an internal additive, a magnetic material such as a metal and an alloy such as ferrite, magnetite, reduced iron, cobalt, nickel, and manganese, or a compound containing any of these metals can be used. As a charge control agent in the invention, various charge control agents which are generally used such as quaternary ammonium salt compounds, nigrosin compounds, dyes comprising a complex of aluminium, iron and chromium and triphenylmethane pigments can be used. From the viewpoint of controlling ionic strength affecting stability at the time of aggregation and coalescence, and reducing waste water pollution, materials which are hard to dissolve in water are suitable.

Examples of a releasing agent used in the toner of the invention include low-molecular polyolefins such as polyethylene, polypropylene, and polybutene, silicones exhibiting a softening point when heated, aliphatic amides such as oleic acid amide, erucic acid amide, ricinoleic acid amide, and stearic acid amide, vegetable waxes such as carnauba wax, rice wax, candelilla wax, Japan wax, and jojoba oil, animal waxes such as bees wax, mineral and petroleum waxes such as montan wax, ozokerite, ceresin, paraffin wax, microcrystalline wax, and Fischer Tropsch wax, and modifications thereof.

At room temperature, these waxes are almost insoluble or completely insoluble in a solvent such as toluene. The wax and an ionic surfactant or a polymer electrolyte such as a polymer acid or a polymer base are dispersed in water, and the resultant dispersion is heated at a temperature equal to or higher than the melting point of the wax while dispersed with a homogenizer having a strong shear imparting ability or a pressure discharging-type dispersing machine (Gaulin homogenizer; manufactured by Gaulin) to form fine particles, whereby a dispersion liquid of particles aving a size of 1 μm or smaller can be prepared.

If necessary, the toner of the invention may contain a polymerizable ultraviolet-ray stable monomer in order to improve weather resistance of an image.

Examples of the polymerizable ultraviolet-ray stable monomer include piperidine compounds, such as 4-(meth)acryloyloxy-2,2,6,6-tetramethylpiperidine, 4-(meth)acryloylamino-2,2,6,6-tetrapiperidine, 4-(meth)acryloyloxy-1,2,2,6,6-pentamethylpiperidine, 4-(meth)acryloylamino-1,2,2,6,6-pentamethylpiperidine, 4-cyano-4-(meth)acryloylamino-2,2,6,6-tetramethylpiperidine, and 1-(meth)acryloyl-4-(meth)acryloylamino-2,2,6,6-tetramethylpiperidine, and at least one of these types may be used.

In order to attain peeling property of a fixed image in an oil-less fixing system, it is preferable that the releasing agent is added in an amount of 5 to 25% by mass relative to a total weight of solid matter of toner components.

The particle diameter of the resulting releasing agent particle dispersion is measured, for example, with a laser diffraction particle size distribution measuring apparatus (LA-700: manufactured by Horiba, Ltd.). In addition, when the releasing agent is used, it is preferable that resin fine particles, colorant particles and releasing agent particles are aggregated, and that a resin fine particle dispersion is further added to the aggregates to adhere resin fine particles to the surfaces of aggregated particles from the viewpoint of attaining chargeability and durability.

Examples of a surfactant used in emulsification polymerization, seed polymerization, pigment dispersion, resin particle, releasing agent dispersion, aggregation and stabilization thereof of the toner preparation of the invention include anionic surfactants such as sulfates, sulfonates, phosphates, and soaps, cationic surfactants such as amine salts, and quaternary ammonium salts, and nonionic surfactants such as polyethylene glycols, alkylphenol ethylene oxide adducts, and polyhydric alcohols. They can be used in combination. As a dispersion means, a rotation shearing-type homogenizer, and a ball mill, a sand mill and a dino mill having media, which are common, can be used.

The toner of the invention can have an external additive. The external additive can be added to surfaces of toner particles in a dried state while the resultant mixture is sheared in order to improve flowing property and cleaning property of the toner. Inorganic fine particles such as silica, alumina, titania, and calcium carbonate, and/or resin fine particles such as a vinyl resin, polyester, and silicone can be used as the external additive in such a case.

Further, in the case where inorganic fine particles are adhered to the toner surfaces in water, examples of the inorganic fine particles include any compound that is usually used as an external additive on toner surfaces, such as silica, alumina, titania, calcium carbonate, magnesium carbonate, or tricalcium phosphate, and all of these compounds can be dispersed with an ionic surfactant, a polymer acid or a polymer base.

In the invention, a surfactant is used for emulsification polymerization of the resin, pigment dispersion, resin fine particle dispersion, releasing agent dispersion, aggregation and stabilization of aggregates particles. Specific examples thereof include anionic surfactants such as sulfates, sulfonates, phosphates, and soaps, cationic surfactants such as amine salts, and quaternary ammonium salts, and nonionic surfactants such as polyethylene glycols, alkylphenol ethylene oxide adducts, and polyhydric alcohols. They can be used in combination. As a dispersion means, a rotation shearing-type homogenizer, and a ball mill, a sand mill and a dino mill having media, which are common, can be used.

After completion of a step of fusing and coalescing aggregated particles, desired toner particles are obtained via an arbitrary washing step, a solid-liquid separating step and a drying step. When chargeability is taken into consideration, it is preferable to sufficiently perform replacement washing with deionized water in the washing step. The solid-liquid separating step is not particularly limited, but, from the viewpoint of productivity, suction filtration, pressure filtration and the like are preferable. The drying step is not particularly limited, but, from the viewpoint of productivity, freeze drying, flash jet drying, flow drying, vibration-type flow drying and the like are preferably used.

<Developer for Developing Electrostatic Images>

The toner of the invention as explained above may be used alone as a one-component developer for developing electrostatic images which is charged on a developing roll with a roll or a blade. Further, the toner may be used as a developer for developing electrostatic images (hereinafter, abbreviated as “developer”) in combination with a carrier. That is, it is preferable that the developer of the invention includes the toner of the invention and a carrier.

The carrier is not particularly limited as long as it is publicly known, and an iron powder carrier, a ferrite carrier, a surface-coated ferrite carrier and the like can be used.

The shape of the carrier may be spherical or undefined. The volume mean diameter of carrier particles is preferably in the range of 20 μm to 150 μm, and more preferably in the range of 25 μm to 80 μm.

<Image Forming Method>

Next, the image forming method of the invention will be explained.

The image forming method of the invention includes the steps of forming an electrostatic latent image on an electrostatic image holding member, developing the electrostatic latent image with a developer to form a toner image, transferring the toner image onto a transfer receiving material, and thermally fixing the toner image, wherein the toner or the developer of the invention is used as the aforementioned developer.

The image forming method of the invention is not particularly limited as long as it has at least the aforementioned four steps, and may include other steps as necessary.

Since the image forming method of the invention forms images using the toner or the developer of the invention, the images have excellent light resistance, developing property and transferring property, sharpness and high quality.

### EXAMPLES

The present invention will be specifically explained by way of examples given below, but the invention is not limited by them.

The following resin fine particle dispersion liquid, colorant particle dispersion liquid and releasing agent particle dispersion liquid were prepared separately, mixed and stirred at a predetermined ratio, and a polymer of a metal salt was added to the resultant mixture in order to ionically neutralize the mixture and to form aggregated particles. Then, an inorganic hydroxide was added to the system to make the system weakly acidic or neutral and the system was heated at a temperature equal to or higher than the glass transition temperature of the resin fine particles to fuse and coalesce the aggregated particles. After completion of the reaction, a desired toner was obtained via sufficient washing, solid-liquid separation and drying steps.

A process for preparing each dispersion liquid will be explained below.

Preparation of Resin Fine Particle Dispersion Liquid (1)

Methyl methacrylate: 460 parts by mass

n-Butyl acrylate: 140 parts by mass

Carboxymethylacrylic acid: 18 parts by mass

Dodecanethiol: 12 parts by mass

The above components were mixed and dissolved to prepare a solution.

Separately, 12 parts by mass of an anionic surfactant (Dowfax: manufactured by The Dow Chemical Company) was dissolved in 250 parts by mass of deionized water, and the above solution was added to the resultant solution to disperse and emulsify the above materials in a flask (monomer emulsion A).

Then, 1 part by mass of an anionic surfactant (Dowfax: manufactured by The Dow Chemical Company) was dissolved in 555 parts by mass of deionized water, and the solution was placed in a polymerization flask. Thereafter, the polymerization flask was sealed tight, a reflux tube was set. While nitrogen was injected into the polymerization flask and the content in the flask was stirred slowly, the polymerization flask was heated to 75° C. in a water bath and retained at that temperature. Further, 9 parts by mass of ammonium persulfate was dissolved in 43 parts by mass of deionized water, the resultant solution was added dropwise to the polymerization flask over 20 minutes via a quantitating pump, and the monomer emulsion A was added dropwise to the polymerization flask over 200 minutes via a quantitating pump. Thereafter, while the content in the polymerization flask was stirred slowly, the polymerization flask was retained at 75° C. for 3 hours to complete polymerization.

Thus, an anionic resin fine particle dispersion liquid (1) having a median diameter of fine particles of 210 nm, a glass transition temperature of 52.5° C., a weight average molecular weight of 19,500 and an amount of solid matter of 42% was obtained.

Preparation of Resin Fine Particle Dispersion Liquid (2)

Isopropyl methacrylate: 540 parts by mass

n-Butyl acrylate: 60 parts by mass

Acrylic acid: 12 parts by mass

Dodecanethiol: 18 parts by mass

The above components were mixed and dissolved to prepare a solution.

Polymerization was conducted in the same manner as in preparation of the resin fine particle dispersion liquid (1) for a shell. Thus, an anionic resin fine particle dispersion liquid (2) having a median diameter of fine particles of 190 nm, a glass transition temperature of 55.0° C., a weight average molecular weight of 21,000 and an amount of solid matter of 42% was obtained.

Preparation of Resin Fine Particle Dispersion Liquid (3)

Ethyl methacrylate: 570 parts by mass

n-Butyl acrylate: 30 parts by mass

Carboxyethylacrylic acid: 18 parts by mass

Glycidyl methacrylate: 6 parts by mass

Dodecanethiol: 12 parts by mass

The above components were mixed and dissolved to prepare a solution.

Separately, 12 parts by mass of an anionic surfactant (Dowfax: manufactured by The Dow Chemical Company) was dissolved in 250 parts by mass of deionized water, and the aforementioned solution was added to the resultant solution to disperse and emulsify the above materials in a flask (monomer emulsion B).

Then, 1 part by mass of an anionic surfactant (Dowfax: manufactured by The Dow Chemical Company) was dissolved in 555 parts by mass of deionized water, and the solution was placed in a polymerization flask. The polymerization flask was sealed tight, a reflux tube was set. While nitrogen was injected to the polymerization flask and the content in the flask was stirred slowly, the polymerization flask was heated to 75° C. in a water bath, and was retained at that temperature. 9 parts by mass of ammonium persulfate was dissolved in 43 parts by mass of deionized water, the resultant solution was added dropwise to the polymerization flask over 20 minutes via a quantitating pump, and the monomer emulsion B was added dropwise to the polymerization flask over 200 minutes via a quantitating pump. Thereafter, while the content in the flask was stirred slowly, the polymerization flask was retained at 75° C. for 3 hours to complete polymerization.

Thus, an anionic resin fine particle dispersion liquid (3) having a median diameter of fine particles of 220 nm, a glass transition temperature of 49.0° C., a weight average molecular weight of 25,000 and an amount of solid matter of 42% was obtained.

Preparation of Resin Fine Particle Dispersion Liquid (4)

Styrene: 460 parts by mass

n-Butyl acrylate: 140 parts by mass

Carboxymethylacrylic acid: 18 parts by mass

Dodecanethiol: 12 parts by mass

The above components were mixed and dissolved to prepare a solution.

Separately, 12 parts by mass of an anionic surfactant (Dowfax: manufactured by The Dow Chemical Company) was dissolved in 250 parts by mass of deionized water, and the aforementioned solution was added to the resultant solution to disperse and emulsify the above materials in a flask (monomer emulsion C).

Then, 1 part by mass of an anionic surfactant (Dowfax: manufactured by The Dow Chemical Company) was dissolved in 555 parts by mass of deionized water, and the resultant solution was placed in a polymerization flask. The polymerization flask was sealed tight, a reflux tube was set. while nitrogen was injected into the polymerization flask and the content in the polymerization flask was stirred slowly, the polymerization flask was heated to 75° C. in a water bath, and was retained at that temperature. 9 parts by mass of ammonium persulfate was dissolved in 43 parts by mass of deionized water, the resultant solution was added dropwise to the polymerization flask over 20 minutes via a quantitating pump, and the monomer emulsion C was added dropwise to the polymerization flask over 200 minutes via a quantitating pump. Thereafter, while the content in the flask was stirred slowly, the polymerization flask was retained at 75° C. for 3 hours to complete polymerization.

Thus, an anionic resin fine particle dispersion liquid (4) having a median diameter of fine particles of 200 nm, a glass transition temperature of 54.0° C., a weight average molecular weight of 18,500 and an amount of solid matter of 42% was obtained.

Preparation of Resin Fine Particle Dispersion Liquid (5)

Methyl methacrylate: 468 parts by mass

n-Butyl acrylate: 144 parts by mass

Dodecanethiol: 12 parts by mass

The above components were mixed and dissolved to prepare a solution.

Separately, 12 parts by mass of an anionic surfactant (Dowfax: manufactured by The Dow Chemical Company) was dissolved in 250 parts by mass of deionized water, and the aforementioned solution was added to the resultant solution to disperse and emulsify the above materials in a flask (monomer emulsion D).

Then, 1 part by mass of an anionic surfactant (Dowfax: manufactured by The Dow Chemical Company) was dissolved in 555 parts by mass of deionized water, and the resultant solution was placed in a polymerization flask. The polymerization flask was sealed tight, a reflux tube was set. While nitrogen was injected to the polymerization flask and the content in the polymerization flask was stirred slowly, the polymerization flask was heated to 75° C. in a water bath, and was retained at that temperature. 9 parts by mass of ammonium persulfate was dissolved in 43 parts by mass of deionized water, the resultant solution was added dropwise to the polymerization flask over 20 minutes via a quantitating pump, and the monomer emulsion D was added dropwise to the polymerization flask over 200 minutes via a quantitating pump. Thereafter, while the content in the flask was stirred slowly, the polymerization flask was retained at 75° C. for 3 hours to complete polymerization.

Thus, an anionic resin fine particle dispersion liquid (5) having a median diameter of fine particles of 240 nm, a glass transition temperature of 55.0° C., a weight average molecular weight of 21,500 and an amount of solid matter of 42% was obtained.

Preparation of Dicarboxylic Acid Compound Fine Particle Dispersion Liquid

Dodecanediacid (melting point 127° C.): 50 parts by mass

Anionic surfactant (Dowfax: manufactured by The Dow Chemical

Company): 5 parts by mass

Deionized water: 200 parts by mass

The above components were heated to 130° C., sufficiently dispersed with a homogenizer (Ultratalux T50: manufactured by IKA Corp.), and dispersed with a pressure discharging-type homogenizer (Gaulin homogenizer: manufactured by Gaulin) to obtain a dicarboxylic acid compound particle dispersion liquid having a median diameter of 160 nm and an amount of solid matter of 21.5%.

Preparation of Colorant Particle Dispersion Liquid (1)

Cyan pigment (C. I. Pigment Blue 15:3: manufactured by Dainippon

Ink and Chemicals, Incorporated): 50 parts by mass

Anion surfactant (Neogen R: manufactured by Dai-ichi Kogyo

Seiyaku Co., Ltd.): 5 parts by mass

Deionized water: 200 parts by mass

The above components were mixed and dissolved, dispersed in advance for 10 minutes with a homogenizer (Ultratalux: manufactured by IKA Corp.) and further dispersed for 2 hours with a sand mill to obtain a cyan colorant particle dispersion liquid (1) having a median diameter of 140 nm and an amount of solid matter of 21.5%.

Preparation of Colorant Particle Dispersion Liquid (2)

A magenta colorant particle dispersion liquid (2) having a median diameter of 120 nm and an amount of solid matter of 21.5% was obtained in the same manner as in preparation of the colorant particle dispersion liquid(1), except that a magenta pigment (dimethylquinacridone C.I. Pigment Red 122: manufactured by Dainichiseika Color & Chemicals Mfg. Co., Ltd.) was used in place of the cyan pigment.

Preparation of Colorant Particle Dispersion Liquid (3)

A colorant particle dispersion liquid (3) having a median diameter of 185 nm and an amount of solid matter of 21.5% was obtained in the same manner as in preparation of the colorant particle dispersion liquid(1), except that a yellow pigment (C. I. Pigment Yellow 93: manufactured by Clariant) was used in place of the cyan pigment.

Preparation of Releasing Agent Particle Dispersion Liquid

Paraffin wax (HNPO190: manufactured by Nippon Seiro Co., Ltd.;

melting point: 85° C.): 50 parts by mass

Anionic surfactant (Dowfax: manufactured by The Dow Chemical Company): 5 parts by mass

Deionized water: 200 parts by mass

The above components were heated to 95° C., sufficiently dispersed with a homogenizer (Ultratalux T50: manufactured by IKA Corp.), and dispersed with a pressure discharging-type homogenizer (Gaulin homogenizer: manufactured by Gaulin) to obtain a releasing agent particle dispersion liquid having a median diameter of 180 nm and an amount of solid matter of 21.5% was obtained.

### Example 1

Preparation of Toner Particles

Resin fine particle dispersion liquid (1): 200 parts by mass

(resin content: 84 parts by mass)

Colorant particle dispersion liquid (1): 40 parts by mass

(pigment content: 8.6 parts by mass)

Releasing agent particle dispersion liquid: 30 parts by mass

(releasing agent content: 6.45 parts by mass)

Polyaluminium chloride: 0.15 part by mass

The above components were sufficiently mixed and dispersed with a homogenizer (Ultratalux T50: manufactured by IKA Corp.) in a round stainless flask, heated to 48° C. with a heating oil bath while stirring the flask, and retained at 48° C. for 60 minutes, 68 parts by mass (resin content: 28.56 parts by mass) of the resin fine particle dispersion liquid (1) was added to the flask and the content in the flask was mildly stirred. Thereafter, the pH of the system was adjusted to 6.5 with a 0.5 mol/liter aqueous sodium hydroxide solution. The system was heated to 95° C. while continuing to stir the system. While a temperature rised to 95° C., the pH of the system was reduced to and retained at around 5.0. After completion of the reaction, the reaction system was cooled, filtered and sufficiently washed with deionized water, and was subjected to solid-liquid separation using Nutsche suction filtration. Thereafter, the resultant solid was redispersed into 3 liters of deionized water at 40° C., and stirred at 300 rpm and washed for 15 minutes. The resultant was subjected to Nutsche suction filtration to separate solid and liquid thereof. This washing procedure was repeated five times. Then, the resultant solid was vacuum-dried for 12 hours. Thus, toner particles were obtained.

The diameter of the toner particles was measured with a coulter counter, and it was found that an accumulated volume mean diameter D₅₀ was 5.2 μm, that a volume mean particle diameter distribution index GSDv was 1.21, and that a surface property index was 1.50. In addition, the shape factor SF1 of the toner particles obtained by shape observation with Ruzex was 130, and the toner particles had a potato-like shape.

1.2 parts by mass of hydrophobic silica (TS720: manufactured by Cabot Corp.) was added to 50 parts by mass of the toner particles, and these materials were mixed with a sample mill to obtain a toner having an external additive. A ferrite carrier having an average particle diameter of 50 μm and covered with polymethyl methacrylate (manufactured by Soken Chemical & Engineering Co., Ltd.) at a mass ratio of polymethyl methacrylate to ferrite of 1%, and the toner having the external additive were weighed so that the toner density became 5%, and both were mixed for 5 minutes with a ball mill to prepare a developer.

Evaluationt of Toner

The developer was loaded in a modified machine of DC1250 manufactured by Fuji Xerox Co., Ltd., a process speed (circumferential rate of fixing member) was adjusted at 180 mm/sec, images were printed on J coated paper manufactured by Fuji Xerox Co., Ltd. as transfer paper, and fixing property of the toner was checked. It was found that oil-less fixing property with a PFA tube fixing roll was good. The lowest fixing temperature was 140° C., and it was confirmed that an image exhibited sufficient fixing property and that the transfer paper was peeled without any resistance. The surface glossiness of the image at a fixing temperature of 180° C. was 45° C., which is good. Developing property and transferring property were both good, uniformity of image density was high, and high chroma was exhibited.

In addition, at a fixing temperature of 220° C., occurrence of hot offsetting was not observed. Occurrence of odor due to volatile matter when 100 images were continuously fixed was organoleptically checked and was not problematic. A light resistance test was conducted and no change of the image was confirmed. On the other hand, the solid fixed image on J paper was folded and unfolded at 180° C., and brittleness of the fixed image was evaluated and was not problematic.

A method of fixing an image with a modified machine of DC 1250 (manufactured by Fuji Xerox Co., Ltd.) comprised the steps of forming an electrostatic latent image on an electrostatic image holding member, developing the electrostatic latent image with a developer to form a toner image, transferring the toner image onto a transfer receiving material, and thermally fixing the toner image.

### Example 2

Toner particles were obtained in the same manner as in Example 1 except that the resin fine particle dispersion liquid (1) for cores was changed to the resin fine particle dispersion liquid (2), that the colorant particle dispersion liquid (1) was exchanged to the colorant particle dispersion liquid (2), and that the pH of a system at the time of heating to 95° C. was maintained at 4.0. The toner particles had an accumulated volume mean particle diameter D₅₀ of 5.10 μm, a volume mean particle size distribution index GSDv of 1.19, and a surface property index of 1.20. The shape factor SF1 was 115, meaning that the particles were spherical.

These toner particles were used to obtain a toner having an externally additive, a developer was prepared, and fixing property of the toner was examined in the same manner as in Example 1. Oil-less fixing property with a PFA tube fixing roll was good. In addition, the lowest fixing temperature was 140° C., and it was confirmed that an image exhibited sufficient fixing property and that transfer paper was peeled without any resistance. The surface glossiness of the image at a fixing temperature of 180° C. was 55%, which is good. Developing property and transferring property were both good, uniformity of image density was high, and the image had high chroma. Slight occurrence of hot offsetting was observed at a fixing temperature of 200° C., but this was not problematic in practical use. Occurrence of odor due to volatile matter when 100 images were continuously fixed was organoleptically checked, and was not problematic. A light resistance test was conducted and no change in color of the image was observed. On the other hand, the solid fixed image on J paper was folded and unfolded at 180° C., and brittleness of the fixed image was evaluated and was not problematic.

### Example 3

Toner particles were obtained in the same manner as in Example 2 except that the resin fine particle dispersion liquid (2) was changed to the resin fine particle dispersion liquid (3), that the colorant particle dispersion liquid (2) was exchanged to the colorant particle dispersion liquid (3), and that the pH of a system at the time of retaining at 95° C. was maintained at 6.5.

The toner particles had an accumulated volume mean particle diameter D₅₀ of 4.80 μm, a volume mean particle size distribution index GSDv of 1.21, and a surface property index of 1.80. The shape factor SF1 was 138, meaning that the particles had a potato-like shape.

These toner particles were used to obtain a toner having an externally additive, a developer was prepared, and fixing property of the toner was examined in the same manner as in Example 1. Oil-less fixing property with a PFA tube fixing roll was good. In addition, the lowest fixing temperature was 125° C., and it was confirmed that an image exhibited sufficient fixing property and that transfer paper was peeled without any resistance. The surface glossiness of the image at a fixing temperature of 180° C. was 50%, which is good. Developing property and transferring property were both good, and uniformity of image density was high.

In order to evaluate blocking property of fixed image, two square pieces each having sides of 5 cm were cut from a sheet of paper holding a solid image fixed at 160° C., the pieces were piled so that images faced each other, a weight was placed on the two pieces so that a load of 80 g/cm² was applied to image-holding surfaces of the pieces, and the pieces were allowed to stand in a constant temperature bath at 60° C. for 48 hours, taken out from the bath, cooled, and separated from each other. It was found that they did not adhere to each other, and image defects and change in glossiness over time were not observed at all. Slight occurrence of hot offsetting was observed at a fixing temperature of 210° C., but this was not problematic in practical use. Occurrence of odor due to volatile matter when 100 images were continuously fixed was organoleptically checked, and was not problematic. A light resistance test was conducted and no change in color of the image was observed. On the other hand, the solid fixed image on J paper was folded and unfolded at 180° C., and brittleness of the fixed image was evaluated and was not problematic.

### Example 4

Toner particles were obtained in the same manner as in Example 3 except that 10 parts by mass of a dicarboxylic acid compound particle dispersion liquid was added to a mixture of the resin fine particle dispersion liquid, the pigment dispersion liquid, the releasing agent dispersion liquid and polyaluminium chloride at an early stage, and that the pH of a system at the time of retaining at 95° C. was maintained at 4.0. The toner particles had an accumulated volume mean particle diameter D₅₀ of 6.50 μm, a volume mean particle size distribution index GSDv of 1.22, and a surface property index of 1.10. The shape factor SF1 was 118, meaning that the particles were spherical.

These toner particles were used to obtain a toner having an externally additive, a developer was prepared, and fixing property of the toner was examined in the same manner as in Example 1. Oil-less fixing property with a PFA tube fixing roll was good. In addition, the lowest fixing temperature was 125° C., and it was confirmed that an image exhibited sufficient fixing property and that transfer paper was peeled without any resistance. The surface glossiness of the image at a fixing temperature of 180° C. was 57%, which is good. Developing property and transferring property were both good, and uniformity of image density was high. Occurrence of hot offsetting was not observed at a fixing temperature of 220° C. Occurrence of odor due to volatile matter when 100 images were continuously fixed was organoleptically checked, and was not problematic. In order to evaluate blocking property of fixed image, two square pieces each having sides of 5 cm were cut from a sheet of paper holding a solid image fixed at 160° C., the pieces were piled so that images faced each other, a weight was placed on the pieces so that a load of 80 g/cm² was applied to image-holding surfaces of the pieces, and the pieces were allowed to stand in a constant temperature bath at 60° C. for 48 hours, taken out from the bath, cooled, and separated from each other. It was found that they did not adhere to each other, and image defects and change in glossiness over time were not observed at all. A light resistance test was conducted and no change in color of the image was observed. On the other hand, the solid fixed image on J paper was folded and unfolded at 180° C., and brittleness of the fixed image was evaluated and was not problematic.

### Comparative Example 1

Toner particles were obtained in the same manner as in Example 1 except that the resin fine particle dispersion liquid (1) for cores was changed to the resin fine particle dispersion liquid (4). The toner particles had an accumulated volume mean particle diameter D₅₀ of 5.50 μm, a volume mean particle size distribution index GSDV of 1.20, and a surface property index of 1.60. The shape factor SF1 was 130, meaning that the particles had a potato-like shape.

These toner particles were used to obtain a toner having an externally additive, a developer was prepared, and fixing property of the toner was examined in the same manner as in Example 1. Oil-less fixing property with a PFA tube fixing roll was good. In addition, the lowest fixing temperature was 145° C. or higher, and it was confirmed that an image exhibited sufficient fixing property and that transfer paper was peeled without any resistance. Although surface glossiness of the image at a fixing temperature of 180° C. was 42%, which is slightly low. Developing property and transferring property were both good, uniformity of image density was high, and the image exhibited high chroma. Slight occurrence of hot offsetting was observed at a fixing temperature of 210° C. Occurrence of odor due to volatile matter when 100 images were continuously fixed was organoleptically checked, and a slight stimulatory odor was felt from a periphery of the fixing machine. A light resistance test was conducted and color change was observed in a greenish image due to yellowing of a cyan image. On the other hand, the solid fixed image on J paper was folded and unfolded at 180° C., and brittleness of the fixed image was evaluated and, as compared with Examples 1 to 4, a large image defect was observed due to chipping of the image.

### Comparative Example 2

An attempt was made to obtain a toner by the same manner as in Example 1 except that the resin fine particle dispersion liquid (1) for cores was changed to the resin fine particle dispersion liquid (5). However, only aggregated particles having a wide particle size distribution were obtained. Nevertheless, at a stage at which a particle diameter reached about 5 micron, the pH of a system was adjusted to 6.5 with a 0.5 mol/liter aqueous sodium hydroxide solution, and the system was heated to 95° C. while continuing to stir the system and, as a result, agglomeration occurred, and toner particles could not be obtained.

TABLE 1

| | | | | | | Comparative | Comparative |
|---|---|---|---|---|---|---|---|
| | | Example 1 | Example 2 | Example 3 | Example 4 | Example 1 | Example 2 |
| Resin fine particle | No. | (1) | (2) | (3) | (3) | (4) | (5) |
| dispersion liquid | Addition amount | 268 | 268 | 268 | 268 | 268 | 268 |
| | (part by mass) | | | | | | |
| Dodecanediacid dispersion liquid | | None | None | None | 10 parts by mass addition | None | None |
| Glass transition temperature (° C.) of binder resin | | 52.5 | 55.0 | 49.0 | 49.0 | 54.0 | 55.0 |
| Colorant particle | No. | (1) | (2) | (3) | (3) | (1) | (1) |
| dispersion liquid | Addition amount | 40 | 40 | 40 | 40 | 40 | 40 |
| | (part by mass) | | | | | | |

| | | | | | | |
|---|---|---|---|---|---|---|
| Addition amount (part by mass) of releasing | 30 | 30 | 30 | 30 | 30 | 30 |
| agent particle dispersion liquid | | | | | | |
| Accumulated volume mean particle | 5.20 | 5.10 | 4.80 | 6.50 | 5.50 | *1 |
| diameter D₅₀ (μm) | | | | | | |
| Shape factor SF1 | 130 | 115 | 138 | 118 | 130 | *1 |
| Surface index | 1.50 | 1.20 | 1.80 | 1.10 | 1.60 | *1 |
| Lowest fixing temperature (° C.) | 140 | 115 | 125 | 125 | 145 | *1 |
| Hot offset temperature (° C.) | >220 | 200 | 210 | >220 | 210 | *1 |
| Uniformity of image density | ◯ | ◯ | ◯ | ◯ | ◯ | *1 |
| Glossiness of image | 45 | 55 | 50 | 57 | 42 | *1 |
| Odor of toner at the time of fixation | ◯ | ◯ | ◯ | ◯ | X | *1 |
| Blocking property of image | — | — | ◯ | ⊚ | — | *1 |
| Light resistance | ◯ | ◯ | ◯ | ◯ | X | *1 |
| Brittleness of image | ◯ | ◯ | ◯ | ◯ | X | *1 |

In Table 1, the mark “*1” means that evaluation was impossible.

Fixing property, various methods of evaluating image, and evaluation criteria

-Lowest Fixing Temperature-

Evaluation of a lowest fixing temperature was conducted by adopting as the lowest fixing temperature the highest fixing temperature at which an image was stained when the image was rubbed with a cloth.

-Hot Offset Occurrence Temperature-

The hot offset occurrence temperature was obtained by confirming the lowest fixing temperature at which a toner was adhered to a fixing roll, and transferred to a rear end of fixing paper.

-Uniformity of Image Density-

Uniformity of image density was obtained by placing a 5 cm square solid image at a central portion and four corners of a manuscript image, observing equality of the image densities of these five points with naked eyes, and performing judgment by ◯ and X.

In Table 1, “◯” means that the image density was uniform and was not problematic in practical use, and “X” means that the image density was not uniform and was problematic in practical use.

-Glossiness of Image-

Glossiness was evaluated by measuring the 75 degree gloss of an image formed on J coated paper manufactured by Fuji Xerox Co., Ltd. with a glossmeter GMD manufactured by Murakami Color Research Laboratory.

-Odor of Toner During Fixation-

Occurrence of odor due to volatile matter of a toner when 100 images were continuously fixed was organoleptically checked and evaluated.

In Table 1, “◯” means that odor could not be confirmed, and “X” means that odor could be confirmed.

-Blocking Property of Image-

Evaluation of blocking property of an image was conducted as follows. First, two square pieces each having sides of 5 cm were cut from a paper holding a solid image fixed at 160° C., the pieces were piled so that images faced each other, and a weight was placed on the pieces so that a load of 80 g/cm² was applied to image-holding surfaces of the pieces. In this state, the pieces were allowed to stand in a constant temperature bath at 60° C. for 48 hours, taken out from the bath, and cooled. Then, whether image defect was generated or not when the pieces were separated was checked with naked eyes, whereby, blocking property of an image was evaluated.

In table 1, “\mathring{∘}” means that when the pieces were separated, no adhesion of the pieces was observed and that image defect or change in gloss over time was not observed. “◯” means that when the pieces were separated, no adhesion was observed, but that slight image defect or change in gloss over time, which is not problematic in practical use, was observed. “X” means that when the pieces were separated, adhesion occurred and that paper tore or image defect occurred.

-Light Resistance-

Light resistance was evaluated by exposing a solid image fixed on J paper manufactured by Fuji Xerox Co., Ltd. to xenon light for 72 hours with a machine SUNTEST CPS+ manufactured by Toyo Seiki, Ltd., and observing change in color of the image with naked eyes.

N Table 1, “◯” means that no change was observed, and “X” means that clear change was observed.

-Brittleness of Image-

Brittleness of an image was evaluated by folding and unfolding a solid fixed image on J paper at 180° C., and observing change in color of the image with naked eyes.

In Table 1, “◯” means that image defect could not be confirmed, and “X” means that image defect could be confirmed.

What is claimed is:

1. A toner for developing electrostatic images, comprising as a main component thereof a binder resin having a copolymer comprising a combination of a high Tg monomer having a structure represented by the following structural formula (1) and a glass transition temperature of 50° C. or higher, a low Tg monomer having a structure represented by the following structural formula (2) and a glass transition temperature of lower than 50° C., and a hydrophilic monomer having a structure represented by the following structural formula (3): 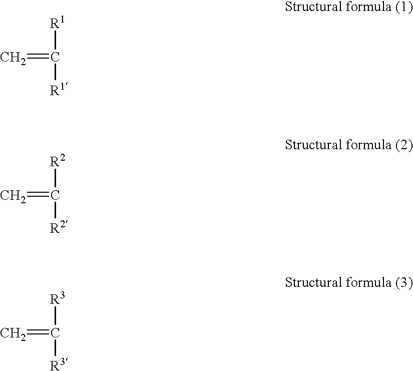
wherein R¹, R² and R³ independently represent a hydrogen atom, an alkyl group, an alkylester group, an alkylether group, a perfluoroalkyl group, a methoxy group, an ethoxy group, a halogen atom, a carbazole group, a pyrrolidone group, a formal group, a cyclohexyl group, an alkyl group having a functional group, or an alkylester group having a functional group, R^{1′} and R^{2′} independently represent an alkyl group, an alkylester group, an alkylether group, a perfluoroalkyl group, a methoxy group, an ethoxy group, a halogen atom, a carbazole group, a pyrrolidone group, a formal group, a cyclohexyl group, an alkyl group having a functional group, or an alkylester group having a functional group, and R^{3′} represents a hydrophilic group.

2. A toner according to claim 1, wherein the toner is prepared by a wet process.

3. A toner according to claim 2, wherein the wet process comprises an aggregating step of obtaining aggregated particles by aggregating particles containing a binder resin in a dispersion in which the particles are dispersed, and a step of fusing the aggregated particles by heating.

4. A toner according to claim 1, wherein at least one of the high Tg monomer and the low Tg monomer is a methacrylic acid ester or an acrylic acid ester.

5. A toner according to claim 1, wherein the hydrophilic group represented by R^{3′} contains any of a carboxyl group, a hydroxyl group, an amino group, a sulfonyl group, and an amido group.

6. A toner according to claim 1, wherein the binder resin contains a cyclic reactive group, and is cross-linked at a temperature higher than the highest temperature at the time of toner preparation.

7. A toner according to claim 6, wherein the cyclic reactive group is any of an epoxy group, an aziridinyl group and an oxazoline group.

8. A toner according to claim 1, further comprising a compound containing a carboxyl group.

9. A toner according to claim 1, wherein a shape factor SF1, of the toner, represented by the following equation (A) is 100 to 140:
SF1=ML²/(4A/π)×100 Equation (A)
wherein ML represents a maximum length (μm) of the toner, and A represents a projected area (μm²) of the toner.

10. A toner according to claim 1, wherein a surface property index value, of the toner, represented by the following equation (B) is 2.0 or smaller:
(surface property index value)=(specific surface area measured value)/(specific surface area calculated value) Equation (B)
wherein specific surface area calculated value is represented by 6 Σ(n×R²)/{ρ×Σ(n×R³)} and, in the equation representing the specific surface area calculated value, n represents the number of particles in a channel (number/channel) in a coulter counter, R represents a channel particle diameter (μm) in the coulter counter, ρ represents a toner density (g/μm³), a division number of the channel is 16, and the intervals of division are 0.1 at a log scale.

11. A toner according to claim 1, wherein an average particle diameter of toner particles is 3 to 9 μm.

12. A toner according to claim 1, wherein a volume average particle size distribution index GSDv of toner particles is 1.30 or smaller.

13. A toner according to claim 1, wherein an apparent weight average molecular weight of the toner is 15,000 to 55,000.

14. A toner according to claim 1, further comprising a releasing agent.

15. A toner according to claim 1, comprising colorant particles whose median diameter is 100 to 330 nm.

16. A two-component developer, comprising the toner according to claim 1 and a carrier.

17. A two-component developer according to claim 16, wherein an average diameter of carrier particles is 20 to 150 μm.

18. A process for preparing the toner of claim 1, comprising an aggregating step of obtaining aggregated particles by aggregating particles containing a binder resin in a dispersion in which the particles are dispersed, and a fusing step of fusing the aggregated particles by heating.

19. An image forming method, comprising the steps of: forming an electrostatic latent image on an electrostatic image holding member, developing the electrostatic latent image with a developer to form a toner image, transferring the toner image onto a transfer receiving material, and thermally fixing the toner image, wherein the developer contains the toner of claim 1.

20. An image forming method according to claim 19, wherein the developer further contains a carrier.
